(19) United States
(12) Patent Application Publication
(10) Pub. No.: US 2013/0321111 A1
(43) Pub. Date: Dec. 5, 2013

(54) Magnetizer utilizing rotated assemblies of permanent magnets

(71) Applicant: Robert Neville O'Brien, Victoria (CA)

(72) Inventor: Robert Neville O'Brien, Victoria (CA)

(21) Appl. No.: 13/135,691

(22) Filed: Jul. 14, 2011

(51) Int. Cl. H01F 13/00

(52) U.S. Cl. CPC H01F 13/003
USPC 335/284

(57) ABSTRACT

Magnetohydrodynamics (MHD) has applications in all electrochemical processes and in a few that are not totally electrochemical in nature. By magnetizing the electrodes or the current collectors through the electrodes so that the vertical, closely and appropriately spaced magnetized electrodes produce a uniform, low magnetic field between them, north pole to south pole, the Lorentz force enhances the natural or forced convection where it is the greatest, very near the electrodes. Because the main internal resistance of an electrochemical process resides in the electrolyte, increasing the speed of transport of charged particles from one electrode to the other greatly reduces this internal resistance. Other treatments such as adding an indifferent paramagnetic ion, an indifferent free radical, completing the magnetic circuit, using a spacer which does not obscure the electrode surface, further reduce the internal resistance, lowering the wasted energy which usually appears as heat in the electrolyte.

### FIELD OF THE INVENTION

In general, this invention relates to performing current-driven [symbol] current-producing electrochemical processes, limited to those for which it is logical to expect advantages from mobilizing the bulk of electrolyte solution between positive and negative electrodes, maintaining a constant state of macroscopic-scale liquid motion to improve mass transport during performance of an electrochemical reaction to produce an intended chemical product.

In operation of current-driven electrochemical processing reactors of the mobilized or, ie., “stirred-electrolyte” types to which the present invention is meant to apply, it is universally understood to be desirable to attain as large a ratio as possible, of electrochemically made product to the amount of direct current electricity fed to cell electrodes over a definite period of time. Whatever the particular scheme of current-driven process may be, its much desired efficiency tends to be hindered by factors such as depletion of reactant and/or excessive accumulation of product in the vicinity of the reaction site, and by poor electrolytic conduction through the liquid electrolyte. Especially in great demand, therefore, are transport-enhancing ways to minimize losses to overvoltages and minimize internal resistance while simultaneously avoiding undesirably reactant depletion and product accumulation.

### BACKGROUND OF THE INVENTION

### Background Information

Applicable to improving “electrolysis in general”, circulating the electrolyte by means of an imposed magnetic field was suggested in U.S. Pat. No. 1,658,872 (Feb. 14, 1928) to YEAGER for “ELECTROLYTIC APPARATUS”. This may be the ‘pioneer’ patent in the field of the present invention.

Direction of magnetic field lines of induction, ie., ‘flux lines’, projected through the electrolyte-filled region between upright electrodes, was not shown in the figures of drawing for the YEAGER patent. However, specified in the text was an arrangement whereby, if such lines had been shown, they doubtlessly would have risen vertically between electrodes, in parallel alignment therewith, hence perpendicular to a horizontal line which may be drawn straight across from the negative electrode to the positive electrode

For reasons which are set forth further below in connection with description of details of how the present invention is clearly distinguishable from the related art, the YEAGER invention is regarded as exemplifying an instance of magnetohydrodynamic pumping, and which, as such, may be presumed operative in absence of any non-magnetic means for producing either a natural or forced convective flow of electrolyte. It will be shown that such MHD-pumping is not the operative principle of the present invention.

Possibly regardable as somewhat closer in art respecting teachings associated with the present invention is U.S. Pat. No. 5,051,157 issued Sept. 14, 1991 to O'BRIEN ET AL for “SPACER FOR AN ELECTROCHEMICAL APPARATUS”. Out of a collection of rather diverse embodiments, the most relevant embodiment was a chlor-alkali production cell using an aqueous sodium chloride solution intended to be propelled through specially slanted diagonal slits in a special spacer between electrodes. Magnetic field flux lines were not shown, but, if they had been, those emerging from magnetized particles embedded in the spacer according to a staggered offset scheme (which was illustrated) could not have been aligned substantially parallel with one another and horizontally straight across the internal circuit region between electrodes as required for the present invention.

Retained from O'BRIEN ET AL is the idea that “indifferent paramagnetic ions” may be included in an electrolyte solution to increase magnetic field assisted convection.

Relevant to the present invention are academic investigations of how electrolyte solutions respond when MHD force is superimposed on pre-existent natural convection. Professors R. N. O'Brien and K. S. V. Sathanam used laser interferometry to permit visual following of pertinent matters like improved diffusion layer thinning at an electrode, associated with MHD-stirring of the conducting solution in electrochemical cells. It was found possible, in a tiny cell containing only a few drops of aqueous electrolyte between electrodes, to use magnetohydrodyanamics to procure improved diffusion layer thinning at vertical planar electrodes, parallel with one another, and suitably spaced apart. By O'Brien and Santhanam, a Technical Note entitled “Magnetic Field Effects on the Growth of the Diffusion Layer at Vertical Electrodes during Electrodeposition” was published at p. 1266 et seq., vol. 129, The Journal of the Electrochemical Society (June 1982), followed by more publications on related subject matter, including: “Electrochemical Hydrodynamics in a Magnetic Field with Laser Interferometry”, Electrochimica Acta, v. 32 (1987); “Electrochemical Hydrodynamics in Magnetic Fields with Laser Interferometry: Influence of Paramagnetic Ions”, J. Appl. Electrochem., v. 20 (1990); and, “Laser Interferometry Study of Mass Transfer Limitation in Electrodeposition of Metals/Polymers”, published as Chapter 9 of Techniques for Characterization of Electrodes and Electrochemical Processes, eds., R. Varma ad J. R. Selma, John Wiley & Sons, Inc., copyright 1991, ISBN 0-4111-82499-2.

In general, it is expected that agreement among knowledgeable relevant artisans will be obtained on the fundamental proposition that if, absent sufficient convection, increased current were forced into an an electrolytically conducting solution between electrodes at which there are thick diffusion layers, an unduly high specific resistance would be expected, in consequence of which a non-negligible portion of energy would go into Joule heating. Preserving thick diffusion layers might make sense in a rare case of using current to generate heat within a particular cell for which an elevated temperature might be desired for some reason. Joule heating, however, is undesirable in cells to which the present invention is intended to apply.

In order to proceed sooner rather than later to summarizing the present invention, several relevant references in addition to those above will be found mentioned at various places amidst the detailed description section further below.

One such further reference will be from Soviet scientific literature, the authors being N. I. Pekhteleva and A. G. Smirnov, who were particularly interested in modifications of natural convection by horizontal magnetic fields, as the present inventor also has been.

Another reference will be to T. Z. Fahidy of the University of Waterloo (Ontario, Canada), who coined a term, “magneto-electrolysis”, which has achieved some limited—not very wide—adoption by others.

Another reference will be to a team of University of Utah Chemists whose studies of magnetic field effects on electrochemical processes have contributed to appreciation that non-aqueous electrolyte solutions, as well as those which are aqueous, can be affected. There will also be brief reference below to something said in a U.S. patent by University of Iowa researchers led by J. Leddy.

A further reference concerns a usually neglected issue of magnetic field effect on solution viscosity, as studied at the University of British Columbia (Vancouver, Canada) by J. Lielmezs and H. Aleman. The changed viscosity effect was left out of consideration in a purportedly comprehensive elucidation of magnetic field effects on electrochemical reactions, from Trinity College (Dublin, Ireland) by G. Hinds, J. M. D. Coey, and M. E. G. Lyons; also briefly referenced below.

Exactitude of imposed magnetic field perpendicularity where it crosses a planar electrode's face has apparently been nowhere previously recognized by anybody as a result-effective parameter, although presented as such hereinafter

### BRIEF SUMMARY OF THE INVENTION

To advance beyond previous disclosures of using magnetic field projecting components, eg. current collectors, electrodes, spacers, and/or casings, magnetized to procure MHD-stirring for enhanced operation of power sources such as secondary batteries and supercapacitors, it is presently proposed to push the frontier of practical utilization of the below-defined MHD-stirring method into the area of industrial electrochemical processing in general, wherever its application is both desirable and feasible.

Especially prominent among specifically targeted subdivisions of the general electrochemical processing area are: 1. electrosynthesis of required forms of pharmaceuticals-making substances; 2. electrodialysis applied variously to making reduced-sodium beverages, to desalination, to waste water purification, to pulp mill spent liquor treatments, etc.; and, 3. bulk chemical commodities production by electrolysis, such as practiced in the chlor-alkali and other industry sectors.

The method of this invention has among its particular objects that of shortening processing time needed by an electrochemical reactor of a given size to procure a given output of targeted product (or products) for a given energy input, compared to expected longer times for procuring the same output in absence of applying the invention,

Another particular object of this invention is to obtain an applied voltage that more closely approaches the theoretical minimum voltage needed to perform a given electrochemical process which usually, ie., in absence of applying the invention, would be expected to incur a greater departure from the theoretical voltage, due to overvoltages and concentration polarization.

An object of invention already alluded to in the above section is to minimize Ohmic resistance and Joule heating in the current-conducting electrolytic solution.

At working electrodes, diffusion layer thinning and mitigation of concentration polarization have long been expected to attend either natural or forced convection of the electrolytically conducting solution between them. Thus, irrespective of how any confirmably present convection may originate, some modest extent of attaining at least some of the objects of invention listed above is usually expected, even without use of an imposed external magnetic field.

What apparently has not heretofore received a warranted extent of recognition is that one and the same cell, tested in one instance with natural convection and without the imposed magnetic field, and then tested again with the convection modified by the magnetic field, registers a lower impressed voltage, at the same current, for the latter instance. That part of a graph presented with the above-cited O'Brien/Santhanam publication in Electrochimica Acta, v. 32, which plots this very significant effect of MHD-stirring is herewith included among below-described figures of drawing.

Also providing strong evidence of the reality of convection enhancement by use of a magnetic field perpendicular to vertical solution flow adjacent vertical electrodes is Table 1 from the same Electrochimica Acta publication, listing flow velocities observed to increase with increased magnetic field strength, covering a range from 0 to 6.2 KG. Even at the smallest field strength used, of 1.19 KG, a ten-fold velocity increase, compared to a 0 KG case, was found.

Moreover, in view of the fact that charging a secondary battery is always an instance of electrolysis, it is relevant to here mention test results from resistance tests carried out by Vizon Scitec of Vancouver, Canada, on two NiMH (nickel-metal hydride) batteries, one of which had been subjected to a proprietary “whole battery magnetization” treatment, and the other of which had not received the treatment. Ratings during charging registered 0.15 ohms smaller for the magnetized battery, even though the small extent of freedom to convect electrolyte in this type battery is less than ideal.

According to the principal and first aspect of the method of the present invention, a B-field of lines of magnetic induction of an imposed external magnetic field intended to enhance convection, hence mass transport, must be so provided and vectored as to permeate the region of convectable electrolyte solution adjacent each current-supplying vertical electrode, specifically with all lines of magnetic induction aligned as nearly parallel with one another as possible, while-extending uniformly horizontally straight across the whole region of the internal electrolytic circuit, so as to perpendicularly intercept any and all vertical components of convective solution flow. The B-field thus is parallel with a nominal, horizontally oriented, electromigration-causing electric field, of the thereby MHD-enhanced cell forming an essential part of any type whatsoever of electrochemical reactor, provided the operation thereof is desirably and feasibly enhanced by applying this method thereto.

It is important to remember, as mentioned briefly above, that this method of (informally so-called) “MHD-stirring” is not advantageously applied to cells wherein stratification of gravitationally conformable strata of solutions of different densities is necessarily left undisturbed. Moreover, because of its effect of reducing internal resistance, the method is also not appropriately applied in cases where resistance (Joule) heating of the electrolyte solution is desired, eg., to assist maintaining a high temperature molten salt type electrolyte in the molten state. Other contra-indications respecting utilizability of the invention include: rare cases where progressive concentration polarization at electrodes may be desired to be left unimpeded, eg., to provide measurable indication of how far some particular batch-type reaction proceeds in a given time; and, rare cases where dendrites or loosely adherent deposits of chemicals on electrode surfaces may be desired, eg., to facilitate collection.

Further light is shed on the bounds of applicability of the invention by briefly considering that not every form of instrumentation for following electrochemical processes analytically is compatible with it.

For example, polarography, the method of analysis first described by Jaroslav Heyrovsky in 1922, involves making every effort to minimize both electrostatic and convective forces so that only diffusion is responsible for transport of the reactant, in order that the current maybe almost entirely limited by the diffusion rate, so that (given a correction for residual current) the direct proportionality of measured diffusion current to the concentration of reactant may be relied on for polarographic analysis. No such measurement and analysis would be at all feasible for a stirred solution cell, of course.

It should by now be apparent to the relevant artisans of ordinary skill in electrochemical processing that the easiest way to ascertain applicability of the method of the present invention to operation of any particular electrochemical reactor for performing any given production process is merely to note whether solution stirring of any kind that includes vertical flow past vertical electrodes, albeit absent the invention, is already recognized by customary practice to be usefully employable already, in the known process concerned. Then, given confirmed desirability and feasibility of such stirring, the artisans may rely on assurances that modifying pre-existent stirring by applying the invention thereto will produce even better results in the areas of: improved diffusion layer thinning, mitigated concentration polarization, minimization of overvoltages, reduction of internal resistance, suppression of dendrites, and so forth.

Significantly, the method of this invention produces cross electrode stirring not otherwise expected for generally vertical flows except if deflected hydromechanically using space-occupying baffles or physically situated turbulators as so-called “motionless mixers”.

An explanation in detail, referring to magnetohydrodynamics principles, appears further below, as there remain three additional aspects of the invention to briefly identify and summarize.

Reluctance-minimizing completion of the “magnetic circuit” portion outside of the electrolytic solution region permeated according to the above first aspect of the invention is its second main aspect. A magnetic circuit fundamentally differs from an electric circuit with regard to not providing a physical analogue to the transport of charge that occurs in a current-conducting electric circuit; neither may an exact equivalent to electrical insulation be found, notwithstanding different permeabilities of different material media. Nevertheless, it can be profitable to compare magnetic and electric circuits respecting some similarities which do exist. For example, the reluctance of a magnetic circuit, which is the reciprocal of permeance, is somewhat similar to electrical resistance or impedance, in that reluctance limits the amount of magnetic flux (likened to a current) sent by magnetomotive force (likened to electromotive force) through the circuit.

The proposed second aspect of the invention, briefly stated, is therefore to make provision for as low as practicable a reluctance in regions of the path of magnetic flux outside the “external” field-permeated electrolytic solution region. This is readily done using high permeability materials such as mild steels, transformer iron, mu metal, permalloys, and so forth, all which afford a further useful feature of magnetic shielding, in addition to delivering maximum magnetic flux to those planar N and S pole faces from which a vectored-as-specified B-field of lines of magnetic induction emerges for projection into the solution. How this aspect ties in with reinforcing the projected field throughout an array of multiple electrodes is also to be described in greater detail hereinafter.

Of special significance respecting instances of reactors using arrays of comparatively closely spaced multiple electrodes, and especially where early release of small gaseous bubbles from electrode surfaces is desired, is the third aspect of the invention, which is the proposal, wherever practicable, to space the electrodes using special dots (or equivalent) of non-conductive material made into electrets.

Summarizing now the fourth main aspect of the invention, I propose that the cross electrode MHD-stirring effect should be enhanced by including indifferent paramagnetic ions in the electrolytic solution. Especially suitable to use are those which are strongly paramagnetic, which can be rendered persistent and unreactive in solution by suitable liganding, eg., by chelating them, and which, whenever necessary or desired, may be removed for recycling from reacted solution by known means and procedures (identified below). Very strongly paramagnetic, hence preferred, candidates for this service are selected from about the middle of the lanthanide series of elements, eg., gadolinium and dysprosium. In general, the stronger the paramagnetism of an electrochemically indifferent additive, the less of it may be used, which is important in order to avoid impeding transport of electroactive ions or incurring a counter-productive solution viscosity increase.

Interplay among one another of the above-identified main aspects of the invention, and especially with the never-before announced optimization of imposed magnetic field perpendicularity to planar electrode faces (new result-effective parameter) will be better understood from the detailed description to be presented hereinafter with reference to the several figures of drawing next briefly described.

### BRIEF DESCRIPTION OF THE DRAWINGS

FIG. 1 is from a publication showing the convective system when the electrodes are too far apart to have one complete circulation path. At a critical distance two convection cells form. This is a figure from a paper using interferometry.

FIG. 2 is a figure from a paper showing the optimum distance of electrodes to complete the convective circuit of the cell thus giving the lowest resistance. In the paper a total of ten runs at increasing voltages and current densities in a Cu electrodeposition cell gave a family of curves of which the two shown are the first and tenth in current density.

FIG. 3 is from a publication and is a series of timed interferometric patterns, drawn from fringes to show how rapidly convective flow begins and increases. Convection was established in less than 13 microseconds even in micro-electrodes.

FIG. 4 is taken from a paper showing the reduction of the required voltage to maintain a constant current with and without a magnetic field, obtained in an interferometer.

FIG. 5 is taken from a paper showing that even when the anode is horizontal and above the cathode which promotes convection, a magnetic field decreases the impressed voltage to maintain a constant current density as calculated from interference fringes.

FIG. 6 shows the result of injecting a small amount of a highly para-magnetic indifferent ion into a commercially obtained nickel metal hydride battery used in hybrid automobiles. Three batteries were tested at 14.3 C before and after magnetization.

FIG. 7 shows the very large effect of magnetization of the electrodes on electrowinning and electrorefining of zinc in a cell with about 60 square centimeter electrodes.

FIG. 8 shows the effect of magnetizing the electrodes when electrolyzing water to produce hydrogen for fuel cells. FIG. 8a shows the reduction in the resistance of the electrolyte with magnetized electrodes; FIG. 8b shows the reduction in impressed voltage in the magnetized cell

FIG. 9 shows the reduction in the voltage of magnetizing the electrodes in the reaction cell to make sodium chlorate from brine solutions.

### DETAILED DESCRIPTION OF THE INVENTION

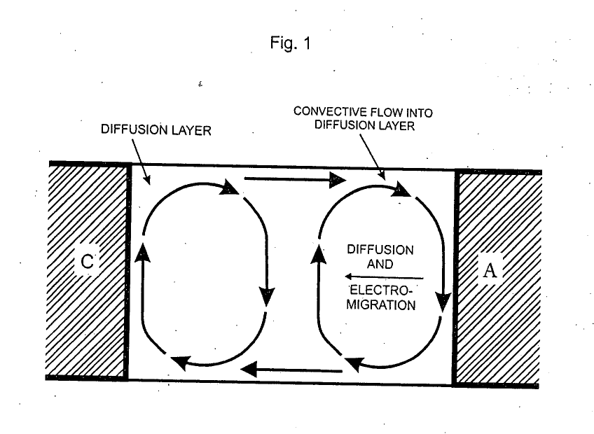

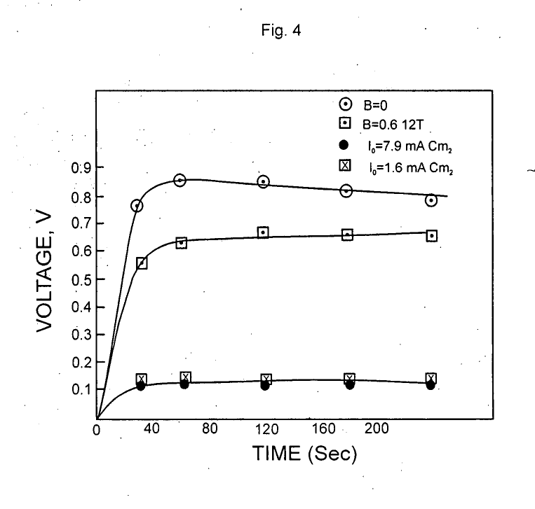

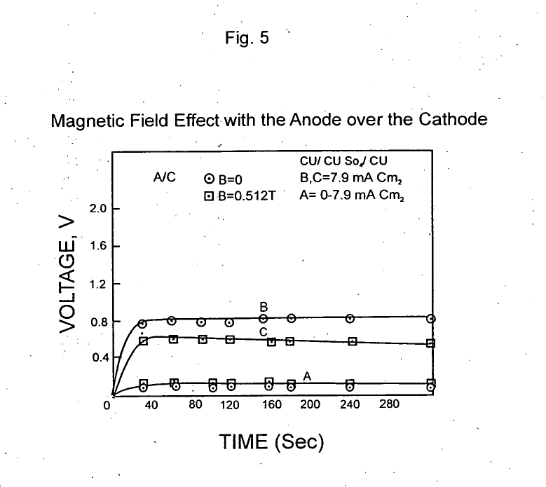

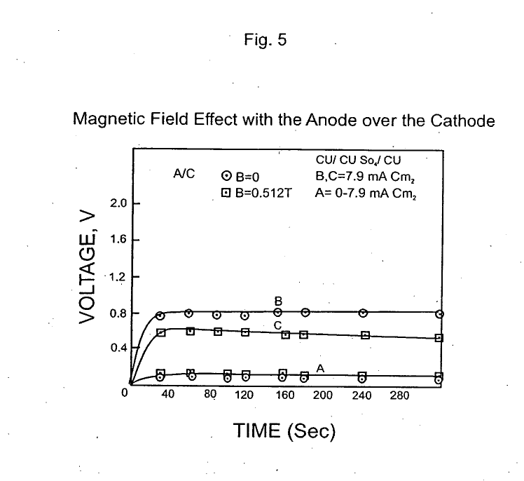

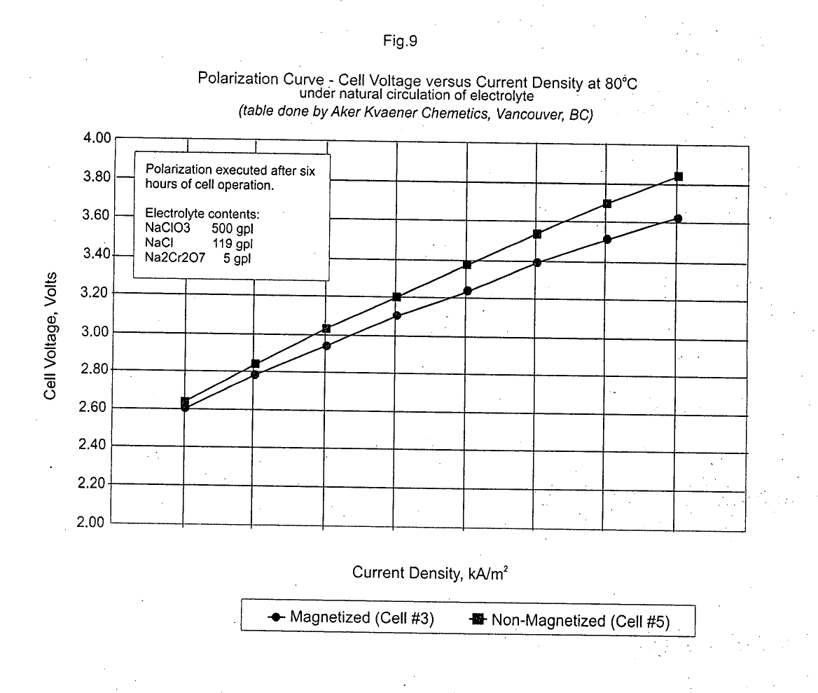

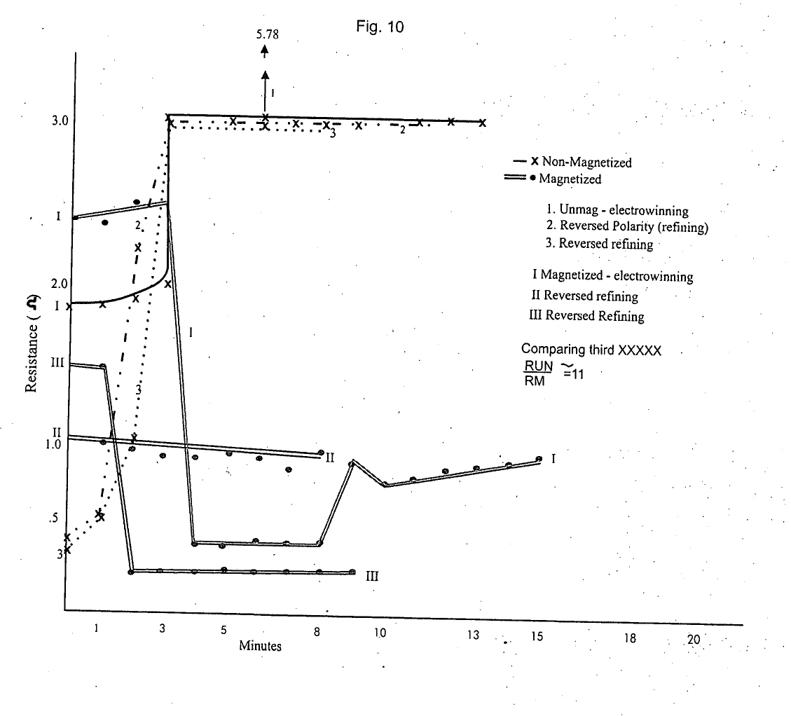

A particularly and especially advantageous feature of the present invention is that it enables instituting, for any suitably arranged and constituted (magnetically enhanced) electrochemical cell, essentially the same voltage-lowering effect that was discovered in the course of academic investigations by R. N. O'Brien and K. S. V. Santhanam, reported by them in the following publications: “Electrochemical Hydrodynamics in a Magnetic Field with Laser Interferometry”, Electrochimica Acta, 32, 1679 (1987); and Electrochemical Hydrodynamics in Magnetic Fields with Laser Interferometry; Influence of Paramagnetic Ions”, J. Appl. Electrochem., v. 20 (1990). To afford artisans easy access to the early interferometric evidence of this important voltage-lowering effect, the graphs, from these publications FIGS. 4 and 5 should be perused and for practical-sized cells the rest of the figures to FIG. 9. No drawing has been made to show an external source of magnetic field as used in FIGS. 1 to 5, where an external source of magnetic field was used and mentioned below. However attaching a permanent magnet, covering at least three quarters of the electrodes to the outside of an electrochemical cell is simple and effective and would give to some extent the same results, if clumsier apparatus, as discussed below.

In all of the FIGS. 1 to 5 the data were obtained in interferometric experiments. This instrument as noted was also an electrodeposition cell. The magnetic field was supplied by an electro-magnet whose output field could be manipulated and was high and generally in the one to seven Tesla range. The amounts of electrolyte were low, varying from as little 0.8 mL to about 2 mL. The concentrations used were usually very low in the range of 0.1 M. The usual electrode height was two mm, or 2 cm, and the total electrode area was 0.4 square cm which should be compared to the usual about 40 square cm battery electrodes. The dropping mercury electrodes previously mentioned are about the same size as those in the interferometer. The numerous works of F. Anson and colleagues on micro-, or point electrodes established that at electrodes much smaller than these, so-called point electrodes, that mass transfer changed radically as the electrodes decreased in area. Although the interferometric work was done just above these areas of rapid change of mode of mass transfer and the authors did diligently attempt to forestall the effects found in very small electrodes there was considerable doubt as to whether the interferometric results held for practical electrodes used in batteries of about 40 square cm or two orders of magnitude larger and with not easily attainable magnetic field strength of several tesla and where permanent magnetic fields attainable were three orders of magnitude lower, they, these data, were consequently ignored by serious practitioners in the field. More especially they were ignored because of the very low concentrations used, at least 20 fold lower than commercial practice and were also un-acidified in the electrodepositions studied. Putting these calculations together suggests that four or more orders of magnitude separate the results from practicality. These experiments were conducted in academically significant ranges, but needed to be tested for practicality in much larger cells plus quantities and concentrations of electrolytes and achievable magnetic field strengths with permanent magnets. Figures six to nine were performed much later and confirm that the results are of practical use.

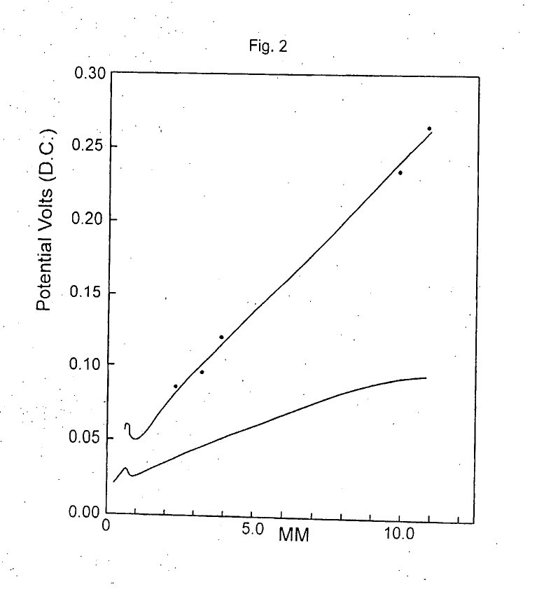

The academic work showed that the product of the magnetic field and the current density was essentially a rising straight line (Table 1) when magnetic field was plotted as the ordinate and current density as the abscissca to the limit of the data obtained. It gave no indication that this was a useful relationship in practical sized batteries that had low field, permanent magnet electrodes. It also showed that there was an optimum distance, FIGS. 1 and 2, at which to place the electrodes for the lowest voltage to obtain a given current density, or that a resistance-electrode optimum separation distance existed. The distance of about 0.65 mm was much smaller than used in some batteries and in almost all industrial electrochemical processes, which was usually in the centimeter range of 2 to 10. The work of the Tobias group at Berkeley (J. Electrochem. Soc., V. 100, p 513 (1952)) showed that natural convection, the dominant transport mechanism in vertical electrodes, was dependent to the three fourths power of the height of the electrode and the four fifths power of the concentration of the electrolyte and that convection largely determined the limiting current density. It remained to be seen if the good results obtained in the interferometric cells in a magnetic field carried over into the practical sizes as predicted by the Berkeley experimenters done in the absence of magnetic field. Table I shows the increasing velocity of stirring with increased magnetic field, which was also done interferometrically where identifiable suspended particles could be video recorded and their velocities measured. Velocities of greater than two orders of magnitude larger than natural convection absent the magnetic field were recorded. It was also found that the best effects occurred in the configuration of the anode over the cathode which is not a useful arrangement in practical batteries or most other electrochemical apparatus.

If the anode is over the cathode, and both electrodes are magnetized, it does not matter how far apart they are—magnetization increases the velocity of convection and the “roll cells” remain, roughly the same size and distribution as in un-magnetized cells.

The use of an electro-magnet to provide a magnetic field is inconvenient in practice and especially in a mobile source such as in a battery pack in a hybrid automobile or any portable energy source because of weight and also high current requirements. The use of a large permanent magnet to give the required magnetic field is also possible, but heavy, clumsy and expensive. It was decided to permanently magnetize the electrodes or current collectors to produce the magnetic field for two reasons, those given above and also to get the best required orientation of the magnetic field and to get the enhancing effect of many oriented magnets. Permanently magnetized electrodes, singly or in a rectangular manufactured battery to give enhanced performance does not appear in the scientific or patent literature nor does the use in diverse electrochemical processes to the best of my knowledge. As mentioned above, the best orientation is with the anode over the cathode, but in batteries this enhancement of discharging output reduces the efficiency of recharging. In large electrochemical cells that are not batteries, the anode over cathode configuration interrupts the MHD stirring helix and is inconvenient to use, produces areas of greater and lesser activity and so will not be considered further. In cylindrical batteries, the electrode or current collector must be magnetized first, pasted, rolled, bottom-sealed, then electrolyte added and top sealed, but the MHD effect and the effect of multiple magnets is still operative, and again is nowhere mentioned in the literature or patent literature.

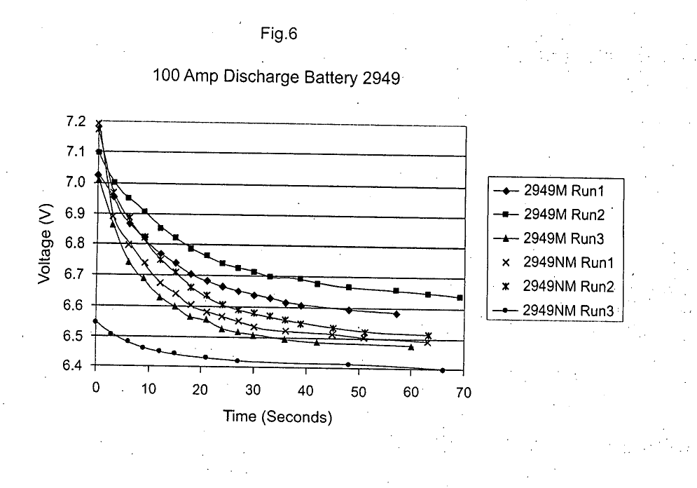

To accomplish singly magnetized electrodes and current collectors .a magnetizing machine was invented, U.S. Pat. No. 6,741,440 B2 (O'Brien, May 25, 2004), Trade Mark OBMII, which gave a field of approximately 50 gauss, or about 100 times the horizontal component of the earth's magnetic field in the temperate zone to electrodes and current collectors. The results displayed in Table 1, showed that the MHD effect is proportional to both the field and the current density and suggests that 50 gauss may not be enough to cause stirring, but FIGS. 6 to 9 show that about 50 gauss is adequate at high current densities and large electrodes to give rapid stirring and decreased internal resistance and yet not be dangerous to credit cards and those wearing electronic pacemakers. This confirms that under magnetized conditions the work of Tobias et al applies and the distance dictated by the radius of the helix (about 0.3 mm) also applies at practical electrode sizes with closely spaced electrodes, such as 29 electrodes per cm in one manufacturer's Li-ion traction battery pouch.

A new magnetizer has been invented and a new patent application made. Tests show that this machine produces about three times the magnetization by OBMII, in about a twentieth of the time and will be trademarked OBMIII. Because the object in commercial electrochemical processes is to operate an electrochemical plant at the maximum current density and so get maximum throughput for lower capital and energy costs, then MHD is a manufacturing change candidate as large and small electrodes can be rapidly magnetized before insertion in the cell, battery or other electrochemical device. The result in applying MHD is much lower capital and power costs because of a lower internal resistance making addition of MHD an attractive addition. Below it will be shown that MHD stirring is a feed-back mechanism which also contributes to lower costs per article or tonne of product at higher current densities. It also means that the higher drain in negotiating hills in a hybrid automobile or a purely electrochemically propelled vehicle with lower energy losses will be advantageous in terms of power and energy used. Estimates of the rate of return vary from 25% to a factor of at least five.

The magnetic field of the permanent magnets produced was low because the magnetizing machine could not produce a high degree of magnetization in ferromagnetic substances with the poles on the flat sides of the sheet. This is because the field produced by a permanent magnet is proportional in a complicated way to the distance apart of the poles on the electrodes which would be of the order of 0.1 mm. For practical purposes, there must be many electrodes in a small volume in batteries; indeed in all commercial electrochemical plants, so the electrodes are limited in thickness and projected field with field lines horizontally across the cell. To show the field lines would require a vastly expanded drawing and so are not shown. Suitable electrode or current collector materials are: the stainless steel 400 series, or Ni or Co and possibly mild steel. Cost of most of these limits the quantities required. Resistance to corrosion by the electrolyte solution is essential. Corrosion resistant coatings are available but represent a further cost, but may be necessary in EC and ECE electrochemical reactions.

Calculation of the magnetic field for a bar magnet is onerous as mentioned above, but, is, generally, calculated at a perpendicular distance from the centre of a pole only, and is proportional in a complicated way to the distance between the two poles. Clearly in a 0.1 mm thick electrode or current collector, very little field would be present using the above noted magnetizing machine. But if the extent of the electrode or current collector was in the range of 30 to 50 square centimeters and two such electrodes or current collectors were placed within 0.5 mm of one another, north pole to south pole, close to the maximum effective field with horizontal lines of force between them would result. Further, in an array of 20 or more as in a battery or most other electrochemical devices, there would be some low permeability material such as the electrolyte and spacers between them, but there would also be a mutually induced magnetic field between the array of magnets used, not herein calculated. The end magnets (electrodes or current collectors) would have field lines transmitted through a dielectric, usually air, as they curled towards the back of the last electrode in the array, so an extra resistance would exist in the magnetic circuit. A remedy will be detailed below. The percentage of ferromagnetic material in the NiMH batteries tested in FIG. 6 was measured to be 61%, or reinforcement of the individual current collector's field would be expected to occur.

FIG. 6 shows the results of a well-known brand of NiMH battery that is commercially available, tested by an independent battery testing company unrelated to the inventor. They were delivered to a city a day's travel away for testing. The independent testing agency “conditioned” the already “spiked” (with manganous ions) batteries were conditioned, that is put into a box kept at 40 degrees Celcius and cycled at least four times, presumably to activate the binder material in the paste. They were then tested at 14.3 C (rated capacity) through three cycles and the results recorded and sent to the inventor with the batteries. The inventor then magnetized them and sent them back to the testing company and they were again tested at 14.3 C. The results were plotted by a computer and the area under the curves of voltage output vs time at 100 amperes was integrated to watt seconds. Table 2 gives these results.

FIG. 6 showed only one battery's results. Three were used and the results averaged. These batteries consisted of a “component” of a traction battery which in fact had six batteries connected in series giving just over seven volts fully charged and a rated capacity of just over 6 whrs. Because the testing company had difficulty with a 100 amp discharge and could only charge at 5 amps the data are not compliant to the instructions given, which was to charge at 100 amperes then discharge at 100 amperes for at least a minute. Only in the magnetized state of the batteries were some able to discharge a constant current of 100 amperes for one minute.

Attempting fairness in the evaluation of the cells in the magnetized and un-magnetized state in Table 2, it was decided that if the data received from a plot of an un-magnetized cell's discharge performance stopped for whatever reason at a given number of seconds, the same sequentially numbered trial for the magnetized state was assumed to have stopped at that time in the evaluation of watt seconds produced, even though clearly not true. This attempt to relate performances fairly has obviously generated some anomalies and avoided others, but the beneficial results of magnetization are quite clear. It should be noted that the first “run-in” discharge for the two states of the batteries was not recorded as the results were in both cases anomalous. After three discharges at 100 amps, the deterioration of the output was large, especially in the first, non-magnetized state. Then after no treatment other than magnetization with the above mentioned magnetizing machine, the initial voltage had risen back to just over 7 volts from about 6.55 V and the output, though it decreased, did so per discharge much more slowly than in the previously un-magnetized state. From this observation, it is asserted that magnetization in some unknown way restores the performance of a damaged battery. It is postulated that the rapid stirring giving nearly bulk solution concentrations at the electrical double layer allows restoration of the NiOOH at the nickel electrode to its “as pasted” activity and with a smoother surface hence likely to survive more cycles.

A previously commercially obtained set of batteries of another brand, made by a different company, but also NiMH was tested by the same testing company and showed that the resistance decreased, rather than increased with increased current density, as was to be expected from theory and practice, without MHD. These tests showed that the measured resistance decreased as the current density increased until three times the rated capacity, then remained approximately constant to 5 C, or decreasing slightly. The testing company at that time could not test discharges above 5C. There is no doubt that at some current draw above 5C, the resistance must rise, if it did not it would violate the second law of thermodynamics. This rise in resistance at some point above 5C seems likely to be the result of viscosity and skin friction in narrow passages. This observation that the resistance decreased with current density is good evidence of a true feed-back system and confirms the feed-back system as initially derived from Table 1 by interferometry.

Electrodes were extracted from the commercial batteries and made into two-electrode, flooded batteries and tested in the presence of two Canadian Government scientists. The electrolyte was spiked with a para-magnetic ion and was about 5M KOH as in the received battery from which these electrodes were extracted. The magnetized batteries compared to the un-magnetized showed 96.5% less internal resistance, when both charging and discharging. Such batteries are efficient energy storage reservoirs returning 93.1% of the energy presented for storage.

Because the metal parts in a battery have almost six orders of magnitude less specific resistance than the electrolyte and the semi-conductor that stores the energy by a valence change is usually about three orders of magnitude less resistive, then more than 99% of the resistance is in the electrolyte, therefore giving back about 93% of the energy presented to magnetized NiMH batteries is efficient, generates very little heat because the resistance is so low compared to most presently available commercial batteries that return only about 25 to 50% of the energy presented for storage and return. Li-ion is the worst performer because organic electrolytes are always up to 20 times more resistant than water based ones. Li-ion batteries could be made with ferromagnetic, magnetized current collectors giving much lower internal resistance and less chance of thermal run-away. Preliminary tests on small Li-ion batteries of 830 mAh at 3.6 V have shown an average of nearly 50% reduction in charging time and greater than 60% in discharged energy through a 10 watt, 10 ohm resistance with a very small LED in parallel to signal the discharge was complete. When a further five ohm resistance was connected in parallel, the difference between magnetized and un-magnetized rose to about 80% as expected with regard to the feed back mechanism encountered in all applications so far. An attempt to lower the output resistance further resulted in both magnetized and un-magnetized to activate their thermal run-away preventive mechanisms. Assuming the thermal runaway device was thermally activated the batteries were cooled in a freezer to about minus twenty centigrade with no rejuvenating effect.

The original tests with the Li-ion camera batteries were done by attaching permanent NdFeB magnets to opposite sides of the batteries. Traction battery Li-ion pouches were run through the OBMIII magnetizer. The results were 18% better on charge and discharge at about 80 amps, well above rated capacity; the second run was 25% better on charge and discharge. A well-known battery testing company had 2% and 7% better discharge output at 1 C. Dissection of the camera batteries showed no ferromagnetic material was present. But the electroactive material was LiFePO4 in the olivine structure, or the iron atoms were in a line and so when the batteries were charged in a magnetic field it would be expected that Fe3O4, magnetite, would be formed from consideration of the thermodynamic energy level differences among the Fe oxides.

Tests of pouch (bag) Li-ion batteries, noted above, making up traction battery packs with NiMnO2 cathodes and with no alteration other than magnetization have shown more than 13% more current output at 0.2 volts greater potential and at 2.2 degrees Celcius lower temperature. Further tests at higher current densities showed a an increase from 18 to 25% increase in output and 2.6 degrees Celcius lower operating temperature and a lower resistance at the higher currents according to the feed back mechanism. Because there is no ferromagnetic material in either Li-ion battery size tested, but a continual increase to the limit of the testing, this increase has been tentatively call “self-magnetization” for lack of a better name.

The flooded, two electrode, made-up NiMH batteries in some cases had no separators and in others had special comb type separators. The combs were made in such a way that the “teeth” of the comb were cylindrical and of about 0.5 mm diameter or less and more than a centimeter apart. Down a cylindrical “tooth” of the comb, dot electrets at intervals of more than one centimeter on each tooth were made by a point injection of electrons. All of the dot electrets had the same polarity and the comb separator was installed so that the positive side of the comb tooth was oriented towards the positive electrode to ensure that the shielding of the active electrode surface was a minimum. The repulsion allowed rapid MHD forced convection to stir the electrolyte adjacent to the electrode and under the rapidly curving teeth of the separator, and thus near the “edge” of the diffuse double layer so as to sweep away any concentration polarization (lowering the diffusion length) and to effectively limit to less than 2% of the active electrode area being obscured. To further elucidate, the small radius of the comb tooth and the charged dots effectively accomplish the reduction in obscuration of the electrode's active face by the separator teeth to a nominal two percent, but it is probably actually lower because of the low radius giving a steeper tangent of contact to the electrode and also with the charge repulsion helping to reduce contact area.

Multiple magnets, oriented N pole to S pole, separated by a dielectric material as in the case of batteries and most electrochemical devices, give a uniform magnetic field between all but the end pairs in an array. The magnetic circuit for these last magnetic current collectors or electrodes must be completed through air or other low permeability substances as this constitutes a magnetic resistance in the circuit In the process of testing the cells of the large type which were at least 35 square centimeters in area shown in FIGS. 6 to 9, for the effect of completing the magnetic circuit, a high permeability mild steel strap was put around the cell and finally the cell was put into a mild steel box with cover. The increased MHD effect, that is, a decreased resistance at high current density, due to an increase in the field between the magnetized electrodes or current collectors in the cell was seen in increased watt hour output and decreased internal resistance on charging and discharging NiMH batteries. The using of MHD, and the magnetic circuit completing effect varied between five and twenty percent depending on a variety of factors, of which the major one was how closely the magnetic field conductor could be fabricated to snugly enclose the cells and of course the type of electrochemical process being conducted. A mild steel box lined with thin plastic increases the MHD effect and provides safety against spills of the corrosive electrolyte. A further beneficial effect was reducing the magnetic field detected outside the steel box, which is analogous to a Faraday cage, so that no magnetic field was detectable, providing greater safety to pace-maker wearers, credit cards and other magnetized devices.

Table 3 is the result of magnetizing the NiMH battery pack of a 2007 Toyota Prius after spiking the electrolyte and driving in several modes. The Toyota dealer read and entered the odometer mileage in the log book. The inventor and an unrelated professional mechanical engineer countersigned the log, but also countersigned the gasoline slip after the Toyota dealer had. The log book used was a hard cover, lined, page-numbered book. The first trial was mostly highway driving and the increase in mileage was only 4%. A second trial with city driving only, gave an increase in miles per Imperial gallon of 53.5% as shown. The best calculation, given the paucity of information supplied by Toyota on the Prius was that the reduced internal resistance of the magnetized battery provided only about 20 horsepower to add to the original 150 from the internal combustion engine. Two battery packs were magnetized and installed in two Prius taxis, driven also in the City of Victoria, Canada. The drivers damaged the transmissions in their taxis within two months using the lower resistance of the battery pack to obtain the 20 horsepower nearly instantly, possibly at a rate of 60 horsepower or more and so to skid the wheels and exceed the transmission's tolerance for electric motor torque. One of the taxis also had a damaged inverter. The inventor's Prius can “lay rubber” but has operated for more than two years with no required repairs and only two trials of maximum torque to the wheels. The problem of lower internal resistance from spiking and magnetizing the NiMH Prius battery pack could be overcome by altering the algorithm of the central computer so that only the tolerable electric motor torque could be delivered to the transmission. The inverter problem is similarly solvable.

Horizontal electrode batteries are used in such devices as lap top computers with means of disposing of the heat generated by long use. NiMH batteries with MHD effects can have increased convection even though the earth's gravitational field is inoperative in one orientation in this mode. The electrolyte and the cell are considered to be stagnant when the cathode is over the anode and the battery is horizontal. It was found that with a strongly para-magnetic indifferent ion present, because the ion is drawn into the field, helpful convection does occur (J. Applied Electrochem. 27, 573 (1997)), which will extend the discharge life of the battery and shorten the charging time. The amount of heat generated is more than with vertical electrodes but still much less than un-magnetized. In the anode over cathode orientation, the MHD effect can approach that in the vertical electrode case. If Li-ion batteries are chosen for the task and they were made with magnetized current collectors, the MHD forced stirring is less, but in the anode over cathode orientation may be sufficient to prevent serious overheating, and of course, for recharging, the device could be charged inverted to get the most available MHD stirring relief from hot spots and general electrolyte resistance heating (Î2R).

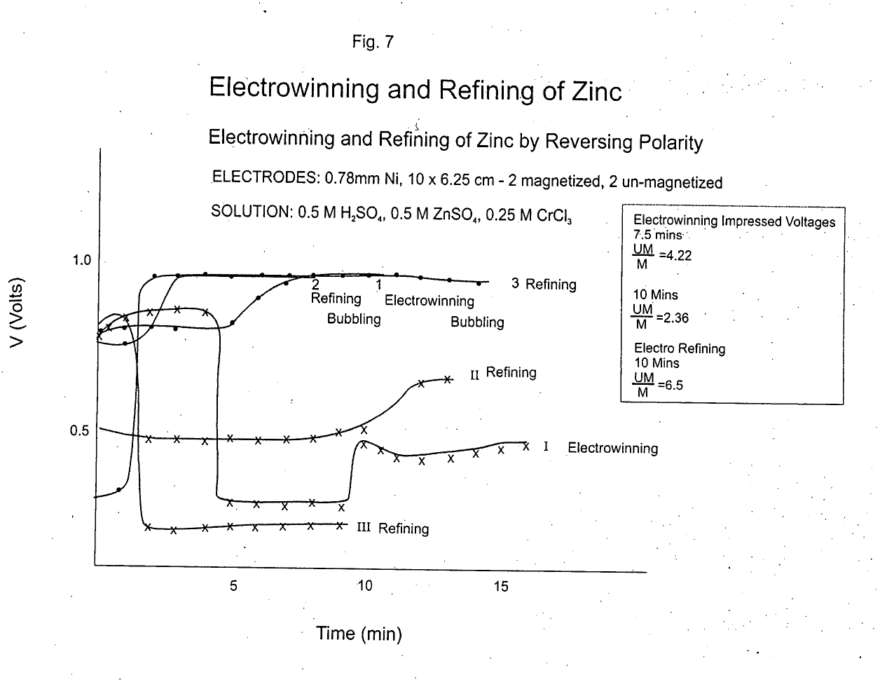

FIG. 7 shows the effect of MHD on electrowinning and electrorefining of zinc using electrodes of 35 square centimeters and Ni electrodes with four molar zinc sulfate and half molar sulfuric acid as electrolyte. The solution used is illustrative only and not that used in the metals industry. The great decrease in internal resistance, more than 11 fold, is proof that MHD is very effective in reducing the watts per kilogram of metal recovered or refined. There were no fractals present in the magnetic cells so in a tank room the extraction and stripping of starter plates could be delayed to greater thicknesses of deposited metal and thus labour, capital and power saved.

In the paper above quoted “Pulsed Electrodeposition of Zinc in Magnetic Fields: Diffusion Layer Relaxation Followed by Laser Interferometry” the absence of fractals was briefly noted due to the vigorous MHD stirring. The results of presently continuing research on Zn-air batteries shows that at five to six cycles there are no fractals on the Zn electrode backed by a magnetized Ni foil current collector. The air electrode was also backed by a magnetized, perforated, Ni current collector. There was a mirror finish on the Zn electrode in the magnetized battery and an obviously rough surface on that of the non-magnetized cell using Ni foil magnetized current collectors in the magnetized cell and the same collectors un-magnetized in the control. The output of the magnetized cell was also much higher. As the research proceeds, results similar to the enhanced results for magnetized NiMH batteries, are expected. No fractals or treeing was evident in the Zn refining experiments. However, in the tank rooms of electrowinning and electrorefining plants, many electrodes are hung in a suitable tank. In electrowinning especially the won metal thickness increases on the cathode starter sheet and the two electrodes become closer together in terms of the thickness of electrolyte between them. An expired provisional patent was applied for several years ago where the software of the controlling computer took the efficiency of the electrowinning (the cathode efficiency) into account and calculated from this and the current passing and using the volume of an atom of the metal concerned, calculated the thickness of the metal won and at a defined thickness activated stepping motors to move the electrodes to maintain a separation for MHD stirring and maximum efficiency.

In some electrowinning and electrorefining processes, the electrolyte (catholyte) in the cathode compartment must be acidic or neutral and in the anode compartment the anolyte must be basic or buffered as in the manganese electrowinning double cell. Preventing mixing of the electrolytes, yet allowing good electrochemical conduction is a problem of selecting a semipermiable membrane sufficiently conducting of cations, a cationic ion exchange membrane, where the counter conduction of hydrogen ions does not exhaust the buffering ability of the anolyte. This membrane must be backed by a magnetized nickel foam (or other metal foam) so that the magnetic field is not too attenuated by a large thickness of dielectric material such as the electrolytes and the membrane or essentially a double cell is needed and concentration polarization does not occur at the membrane.

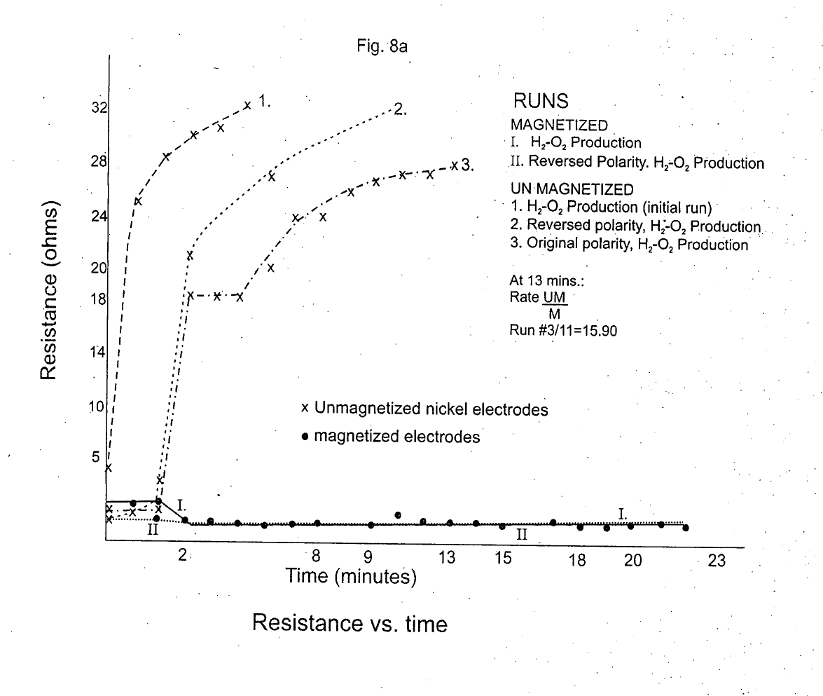

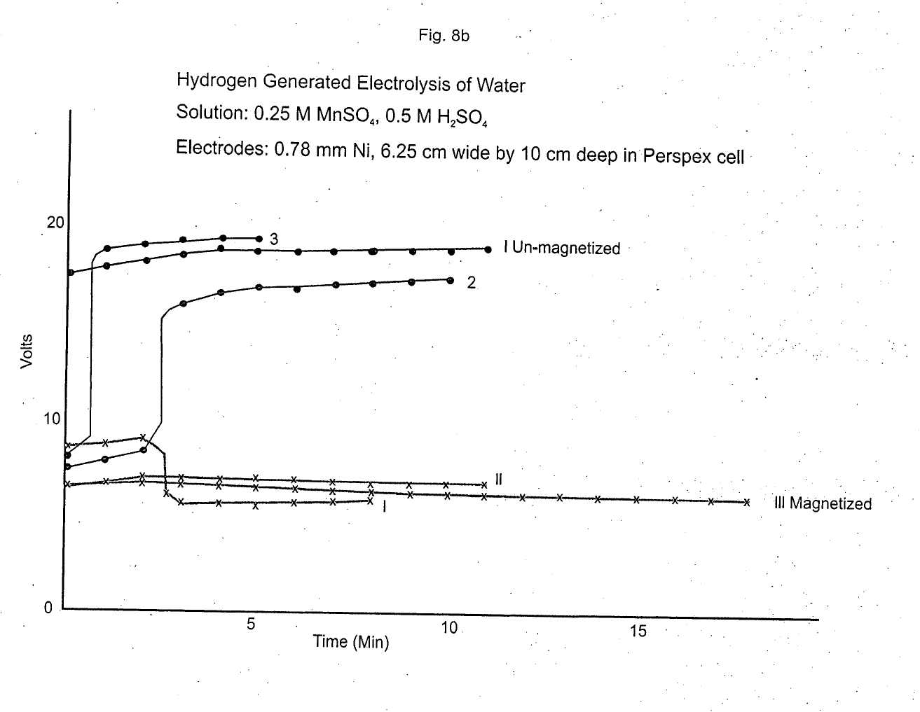

FIG. 8 illustrates the effect of MHD on the electrolysis of water. Reduction of the resistance by more than 17 fold means that large scale production of hydrogen by electrolysis of water is cheaper than steam reforming of natural gas, may even be cheaper than gasoline for internal combustion engines.

The electrolyte is not that used commercially, consisting of half molar sulfuric acid and has only been used as a demonstration of MHD effectiveness.

FIG. 9 shows the effect of magnetizing the cathode, a mild steel electrode, and supplying an identical magnetized electrode, the anode, which was then vapour coated in titanium then coated with catalyst and both placed into a brine electrolyte to produce sodium chlorate for the pulp and paper industry to use for bleaching. As is well known, this is an EC (electrolytic, then chemical) reaction. First the chloride ion is oxidized to hypochlorite ion at the anode in the presence of chromate ion. The hypochlorite diffuses away from the anode then reacts with more chloride ion to produce chlorate ion in the strong basic solution. The figure demonstrates the universality of MHD stirring to improve electrochemical processes of all kinds even though in this case rapid stirring is already present as the hydrogen at the cathode bubbles are rising rapidly. This is confirmation that convection of any kind, natural or forced gives MHD effect in magnetized electrochemical cells.

These data are included to show tonnage quantities of electrochemically produced chemicals including EC and presumably ECE electrochemical processes are more efficient with MHD stirring. The chemical reaction (C) which occurs in the well-stirred bulk of the electrolyte is also hastened by stirring after which another E, electrochemical reaction, may occur.

If nickel foam is magnetized and the thickness is about 1.6 mm and this is now crushed to about 0.4 to 0.2 mm, even though some of the domains are re-oriented and so some of the magnetic strength is lost, the crushed foam still retains more than 60% of the original magnetization, or the field is much larger than would be produced by the magnetizing machine on a 0.2 mm electrode (recalling the dependence of field on the separation of the poles previously mentioned), and two such electrodes placed at the optimum distance apart would give a greater effect and a higher limiting current density in batteries or any electrochemical process to which these electrodes are appropriate plus a 90% decrease in weight. Foams of many thickness and materials are now available.

The use of crushed, magnetized Ni and MH foam when used in NiMH batteries reduces the weight of the batteries by up to 50% for the same or smaller volume and gives a much increased output, greater than that shown in FIG. 6.

The crushed, magnetized current collector is useful in Li-ion batteries where the battery weight is substantially lowered, the crushed foam being approximately one tenth of the weight of solid Ni and of course lighter by about the same amount than the Cu foil, and a little less dense than the Al foil. Increased MHD stirring alleviates heating problems by rapid distribution of heat in the battery for more rapid radiation by e.g. a mild steel outer shell used to complete the magnetic circuit making large Li-ion traction battery packs much safer. The more paramagnetic chelated ions are only sparingly soluble in organic solvents but free radicals are soluble. There are indifferent paramagnetic free radicals that can be added to Li-ion batteries to improve MHD stirring, some having as many as three unpaired electrons to give enhanced paramagnetism and some which will mildly chelate Li ion. In some Li-ion traction packs, pouch batteries are hung on plastic frames to allow cooling air between packs. A presently ongoing experiment is to use crushed magnetized metal foam magnets in this space to take up less than one quarter of the air cooling space on some inspected traction batteries that were less than one centimeter thick and to also use them inside the bag batteries as magnetized current collectors. The use of magnetic current collectors may require that these be plated with Cu on one side and Al on the other and then properly oriented in the cell to show the same metal such as Cu and Al when a Cu and Al foil is replaced. As mentioned above on-going research has shown about 25% better output when run through the magnetizing machine with no other alteration.

The crushed magnetized Ni foam current collector has been successfully used in the zinc air battery, the zinc being plated onto one side of the current collector, thickly enough to seal that side and prevent any electrolyte seeping through to the air electrode. The spacer is placed between it and the air electrode, and the air electrode supported by another Zn coated, magnetized current collector to supply the Zn for the next cell remaining porous enough to allow a good supply of air to the air electrode. The battery weight is much less and the efficiency of charge and discharge increased.

The electrolyte concentration can be varied between less than one molar and greater than eight molar. The low value allows common paramagnetic ion solution and the larger the effects of water loss without a reservoir. Minor, simple construction alterations are required to allow for electrolyte concentration. In the low concentration mode a reservoir with an osmotic membrane allows only water to enter the cell and this reservoir is back with a gravity feed larger pure water reservoir.

The three battery systems that stand out as good candidates for MHD because everything in them other than the electrolyte is ferromagnetic, and which do not need the complication of supplying a ferromagnetic current collector are NiMH currently widely used in many tools, household articles and most hybrid automobiles and the NiFe, nickel iron battery used for storing intermittent energy such as solar or wind in isolated situations because of its reliability for many years and many cycles. MHD brings NiFe's discharge performance into the same range as modern batteries. A battery that can have some of its parts essentially ferromagnetic is the third type that qualifies as being simple to magnetize.

The third type, Li-ion showed that without previously magnetized current collectors as detailed above, but with LiFePO4 cathodes in the olivine structure and also NiMnO2 cathodes, the batteries can be magnetized, the actual chemical reaction is unknown, but the increased output increases with cycling and has therefore been tentatively labeled “self-magnetization”. Improvement in output would be improved with addition a paramagnetic ion or free radical. Both types have been magnetized and for camera batteries, a 67% increase in output recoded. In magnetized, pouch, traction batteries up to 25% better output at high current drain has been recorded.

High coercivity in the electrodes such as in Fe, Ni and Co prevents accidental demagnetization of the electrochemical devices. The best modern magnets, NdFeB with a high coercivity have a low Curie point of about 316 Celcius vs over 700 C for the three ferromagnetic elements referred to above. Organic and inorganic ferromagnetic systems generally have low coercivity and low electrical conductivity and further, generally produce low magnetic fields and so are presently unsuitable to produce MHD stirring in electrochemical systems that are required to be rugged.

Because of the extremely rapid stirring of the electrolyte, the “leveling” chemicals usually added to electro-polishing baths which in fact adhere to the more active sites to give a more generally lower activity but suppress pitting, can be left out of the bath, removing this source of extra resistance. This effect has been seen in the recycling of Zn-air batteries where the zinc electrode had a mirror finish thus saving chemicals and providing ease of making up the bath, saving time and leaving a polished finish in electroplating suitable for immediate application of another surface layer, either decorative or corrosion resisting.

The process of electro-machining, especially breadboards for electronic devices has been briefly investigated interferometrically but not published. With a scribed impervious coating, vertical walled trenches of less than a micron wide could be produced. In large scale, the work would be done in the gap of an electromagnet, or backed with a permanent magnet, suitable to the work and with another situated behind and possibly attached to the cathode. The gap can again be maintained at the lowest resistance distance by the usual devices used to maintain a gap large enough for violent mechanical stirring, so can be set to maintain about 0.5 mm of the electrodes. The electrolyte for machining square holes is usually heated and stirred very rapidly mechanically, both of which can be dispensed with if MHD stirring is used. The electro-machining of chips and bread boards for electronic devices after a scribed, resistive coating has been applied usually results in “undercutting” leading to “cross-talk” so that the number of electronic junctions per area is restricted.

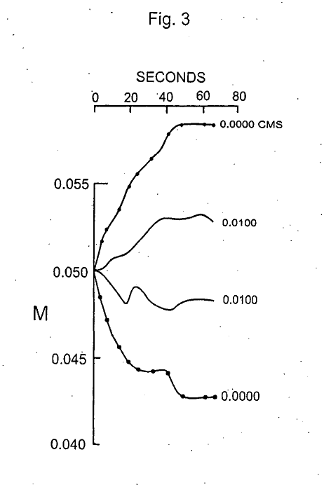

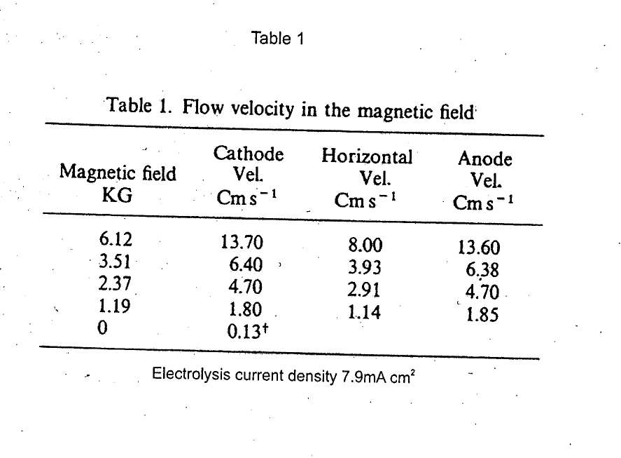

Recent research into supercapacitors (ultracapacitors) as an energy reservoir, where the term refers to double layer capacitance enhanced by Faradaic effects from oxidation and reduction of a substance, usually a metal oxide such as ruthenium, so that as the capacitor is charged or discharged, an ionized electrolyte such as a solution of sulfuric acid is required to absorb ions or charge. In the course of charging and discharging density differences are generated in the controlled, specially sized pores containing for example Ru3+/Ru4+, some natural convection will be generated, even if the supercapacitor is operated within its time constant which may be as short as five seconds since convection would have started (FIG. 3) at about 13 microseconds. Causing the high surface area material, often controlled-sized, porous, active carbon, plus any metal or other oxide to adhere to a thin sheet of ferromagnetic material, previously magnetized and closely spaced to thee other part, not an electrode, which is also a magnetized sheet of a ferromagnetic material, not corroded by sulfuric acid such as Co or type 400 series stainless steels or other corrosion protected steel or ferromagnetic material would reduce the time constant because the MHD stirring would reduce the diffusion distances, or alternatively. In practice a smaller array of capacitor plates could be used to get the same power output to the limit of the capacitor's time constant. Other anti-corrosion coated ferromagnetic materials such as mild steel or nickel may also be used, especially if the electrolyte is not water based. The above coterie of ideas has been explained in U.S. Pat. No. 6,556,424 (O'Brien, Apr. 29, 2003) and is now superceded by the use of crushed, magnetized Ni foam made impervious to the electrolyte by a light coating of lead or other metal. The specially activated carbon granules with ruthenium oxide are attached to the crushed, coated, magnetized Ni foam, the electrolyte coated, magnetized, crushed Ni foam closely placed to form the supercapacitor with MHD stirring and much reduced weight.

In the tests of NiMH batteries (FIG. 6), the recovery of the initial voltage and ability to absorb charge and discharge 100 amperes or 14.3 times the rated capacity means that magnetization can restore some of the damage done by discharging at very much higher than the rated capacity. In the on-going research in Zn-air batteries, improved cycling and recovery is expected, but some other mechanism must be present in the NiMH batteries. In the absence of a proven mechanism, but on the evidence presented it is claimed that magnetized batteries will have superior cycling ability and that the usual 1000 cycles for NiMH in laboratory tests and more than 500 in service would be greatly exceeded and the recently advertised 100 cycles Zn-air will rise to match un-magnetized NiMH batteries. It is here postulated that failure of the pasted electrodes of NiMH batteries is due to expansion and contraction with change of valence in the Ni electrode in specific areas of greater energy so that cracking occurs adjacent to these areas. Conversely when rapid MHD stirring occurs the expansion and contraction occurs over the whole electrode equally so that allowance can be made for smaller overall expansion and contraction in elastic electrode boundaries.

MHD stirring can be used in processes that are not electrochemical in nature. An example is in membranes used for separations. A reverse osmosis membrane cast in and onto a magnetized Ni crushed foam sheet, with another crushed, magnetized Ni foam sheet at the optimum-distance which may not be 0.5 mm, to give MHD stirring is possible. The crushed foam admitting the substrate, possibly seawater, is not an obstruction to flow, the pressure used on vertical membranes can be higher because of the Ni foam backing or in the membrane itself, and the natural convection which has been observed (Forgacs,Leibowitz, O'Brien and Spiegler, Electrochimica Acta, 20, 555 (1975)) at RO membranes will be enhanced in vertical sheet seawater desalting apparatus. The enhanced flow will reduce the concentration polarization, present in seawater desalting, prevent the small amount of CaSO4 in seawater reaching saturation which could precipitate, plugging the pores of the RO membrane, and thus increase flow and decrease maintenance in disc-type desalinators. It is anticipated that kidney dialysis machines would be improved with MHD stirring as well as membrane recycling of waste water in any chemical process. Zn-air batteries with the KOH electrolyte below 8 M require a water reservoir. A forward osmosis membrane between the electrolyte and the water supply keeps the battery from drying out. The water reservoir is a solution of KOH below that of the electrolyte solution. The concentration of the KOH in the water reservoir is adjusted to the expected relative humidity or otherwise, so that forward RO just supplies the exact amount of water required to maintain electrolyte concentration. Another water reservoir can be outside of the battery pack and arranged to supply water by gravity control and also be made to be easy of access for addition of water. The water need not be distilled water since the RO membrane will pass only water. Maintenance will consist of adding tap water as often as monthly in desert regions and renewal of the complete contents of the water supply system about once per year. In some makes of Zn-air, the electrolyte must be much lower than 8 M because the zincate may be in the form of solid particles since its solubility in KOH decreases with increasing KOH concentration and may clog the air electrode so much less, as low a 1M KOH may be required, but the means of renewing the electrolyte can be altered in concentration and still function.

It needs to be recalled that all of the effects of MHD are known from the work of Fahidy (T. Z., J. Applied Electrochem. 13, 553 (1983)) and others, with an electromagnet placed across the electrochemical cell or battery, but the power to the electromagnet must either be provided by a battery or other source, and the field will decrease through the many electrodes usually employed rather than being enhanced by the array of permanent magnets, the electrodes. Electromagnets are too heavy, bulky and energy thirsty to be considered for mobile energy reservoirs. Modern NdFeB magnets may also be employed on the outside of an electrochemical cell, but again the field will fall off towards the centre of the array of electrodes, and it may be that they will need extensive and expensive shielding to be safe. These devices, an electromagnet or a permanent magnet, can be effective even though the results in the interior of a cell will be decreased, but they represent extra equipment occupying space, extra expense, extra weight and are less effective to provide MHD compared to permanently magnetized electrodes or current collectors in collections of electrodes or current collectors in modern batteries and electrochemical process equipment. A battery manufacturer may also use such a magnetizing set-up, sending a ferromagnetic current collector strip through the poles of an electromagnet or a permanent magnet. In some cases this may be the chosen method but some of the above noted detractions may yet obtain. When there are less than twenty electrodes or the battery is less than a centimeter thick, parallel sided and less than 20 square centimeters on a side, attaching a flexible modern magnet to individual batteries will be more expensive, but still effective in giving MHD stirring if there is free electrolyte present. This effect has been demonstrated in camera batteries of only 0.78 amp hours with thin modern magnets attached to the outside giving an enhanced output of as much as 80% as noted above. As the size of the electrode increases their cost to magnetize by OBMMIII the electrode per square centimeter is reduced, in for example, electrowinning of Zn, with electrodes of the order of two meters by two meters. In contrast, the pole piece of a replacing electromagnet would be very large and heavy. Placing of the largest permanent magnets on large electrodes would require complicated and great expense for the magnets since they can only be cast in sizes much smaller than for one to cover a four square meter electrode, and that they strongly repel each other as they complete the magnetic circuit in confined spaces between them. This effect can be reduced by mu metal, transformer iron or other non-magnetizable metals at further extra expense and added weight. It is possible in some cases to use thin, high field attachable magnets to get sufficient MHD effects. This possible application must not be ignored.

Electrolysis of water to produce hydrogen for fuel cells or industries that need hydrogen in their processes is used only when absolutely pure hydrogen is needed, but electrolysis of water has long been used to produce heavy water for nuclear fission reactors. The system is useful for producing heavy water because of the isotope effect, heavy water is electrolyzed last in a mixture. With MHD the cost of heavy water would be reduced and the separation of other isotopes such as 6Li from 7Li for fusion reactors would be speeded and reduced in cost.

In summary, the use of magnetohydrodynamic stirring produced by magnetizing the electrode or current collector, made of solid or crushed foam of a ferro-magnetic material, with a high magnetic coercivity, placed at the optimum electrode distance with a suitable indifferent para-magnetic ion or free radical present, the magnetic circuit completed, and with an electret comb separator, produces a much reduced internal resistance in any and all electrochemical reactions, even in EC and ECE processes, including batteries where it increases output and cycle life. In all electrochemical cells a feed-back mechanism is engendered, and in supercapacitors, MHD stirring reduces the time constant. In the electrochemical industries in general MHD reduces the internal resistance of cells as in the chlor-alkali industry and and in many products. MHD can be used in other tonnage industries such as adipic acid as a precursor for nylon 66 production, to resolve fermentation racemates in the pharmaceutical industries, increase through-put and lower power cost in the metal production industries and most of the other electrochemically based industries, including purification of used solutions, seawater desalting and isotope separation. The permanent magnet electrodes used only increase the stirring by convection engendered by the earth's gravitation field for very little extra cost to magnetize and a very large decrease in resulting costs of all electrochemical processes. The essence of the invention then is recognizing that the Lorentz force can be understood to provide a force perpendicular to the electric field and the magnetic field as in the right hand rule to determine which way an electric motor will turn and that this applies to electrochemical processes, not in the way perceived by other inventors assuming that the electric current is the electrolytic current measured externally between the electrodes, not that the ionic stream of the upwelling of the electrolyte at the cathode (and the sinking at the anode) is the convective current that can be magnetically enhanced by the Lorentz force (forced or natural convection or a combination) with the magnetic poles on the faces of the electrodes.

What I claim is:

1. An electrochemical system composed of an anode and a cathode or a series of anodes and cathodes separated by an electrolyte and held at a constant separation by a separator of indifferent and non-electrically conducting material or as in electrowinning no separator with an arrangement to maintain an efficient and safe gap between the electrodes, with the electrodes magnetized and the magnetic circuit completed externally by a high permeance box or cell tank containing the electrodes, one or more of the constituents of the electrical system capable of being converted to a natural permanent magnetic material,

2. when the electrodes are not ferromagnetic, backed by magnetized current collectors, the electrolyte to be a concentration of between 0.1 M and 10M water or other solvent with a dielectric constant between 5 and 80 and containing the electroactive material in solution and a paramagnetic indifferent ion or free radical of less than 10% by weight,

3. the magnetization to produce a magnetic field in air of up to 50 gauss or greater, producing rapid magnetohydrodynamic (MHD) stirring of the electrolyte, with a high permeance material completing the magnetic circuit, which in very thin batteries may also be the source of magnetic field and the battery container,

4. the electrodes to be separated by a stiff, highly resistant chemically and electronically resistant material in the shape of a comb with teeth between 0.25 and 1 mm in diameter and one centimeter to five centimeters apart with electret dots down the length of the teeth at one centimeter to three centimeter mutual distances with the positive side of the electret dot oriented to the positive electrode, the back of the comb to be 0.2 mm to 0.4 mm thick, when the anolyte and catholyte must be separated, the comb or other type of separator, may be backed by a severely crushed, magnetized Ni foam sheet, essentially producing a double cell both with MHD stirring, and

5. when no separator is needed as in electrowinning, a computer containing suitable software calculates the thickness of the deposited metal and maintains the most efficient and safe distance between cathode and anode and

6. when used in metal air electrodes such as zinc- air, and generally; current collectors may be crushed, magnetized metal foams, plated with the electroactive metal, and

7. the magnetized cell may be arranged to be an electropolishing or electromachining cell,

8. and in any electrochemical system where the electrodes or current collectors cannot be magnetized or replaced with ferromagnetic ones, the attachment of permanent, thin, flexible, attachable modem magnets to produce the MHD stirring effect.

9. In another manifestation, the plates of a supercapacitor containing an electrolyte are magnetized to give MHD stirring, the electrolyte to contain an indifferent paramagnetic ion or free radical.

10. In another manifestation, the crushed, magnetized, ferromagnetic foam electrodes have a reverse osmosis membrane or other semi-permeable membranes cast on them, with another of opposite polarity placed such as to cause MHD stirring along the face of the membrane to prevent concentration gradients or precipitation of sparingly soluble constituents.
